(19) United States
(12) Patent Application Publication
(10) Pub. No.: US 2007/0165011 A1
(43) Pub. Date: Jul. 19, 2007

(54) HAND-HELD DEVICE WITH CHARACTER INPUT ROTARY WHEEL

(75) Inventors: Chin-Feng Chen, Shenzhen (CN); Tay-Yang Lin, Shenzhen (CN); Xiao-Guang Li, Shenzhen (CN); Kuan-Hong Hsieh, Shenzhen (CN); Te-Yao Yeh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/566,234

(22) Filed: Dec. 3, 2006

(30) Foreign Application Priority Data
Jan. 18, 2006 (CN) 200610033271.2

(51) Int. Cl. G09G 5/00

(52) U.S. Cl. 345/184

(57) ABSTRACT

A hand-held device is provided. The hand-held device includes a rotary wheel, a switch, a character region, and a controller. The rotary wheel has a plurality of positioning inputs. The character region includes a plurality of icon areas corresponding to the positioning inputs. Each icon area includes a plurality of characters. According to a positioning input the rotary wheel locates, the controller selects characters of the corresponding icon area. According to a count the switch is operated, the controller inputs a corresponding character of the characters selected. The above-mentioned rotary wheel can replace keyboard in the hand-held device.

### BACKGROUND OF THE INVENTION

1. Field of the Invention

The present invention relates to a hand-held device, and particularly to a hand-held device with a character input rotary wheel.

2. Description of Related Art

Hand-held devices, for example, mobile phones, and personal digit assistants, usually adopts a keypad to input characters. The keypad typically has fewer keys than a QWERTY keyboard. Furthermore, a key of the keypad is smaller than a key of a normal keyboard. A user usually needs to operate keys on a keypad a plurality of times to input one character. It is uncomfortable to operate small sized keys.

Rotary wheels are used as input apparatus in hand-held devices. For example, U.S. patent application Ser. No. 10/259,159, published May 22, 2003, entitled “Method and apparatus for use of rotational user inputs,” it discloses a media player. The media player includes a display screen and an input device. The display screen displays media items. User rotates the input device to select a media item. U.S. Pat. No. 6,842,169, issued Oct. 19, entitled “Hand-held electronic device with multiple input mode thumbwheel,” it discloses a hand-held electronic device. The electronic device includes a thumbwheel as an auxiliary input device. Rotary wheels are used to select menu items, move cursor, but are unable or inconvenient to use as character input device.

Therefore what is needed is a hand-held device with a character input rotary wheel.

### SUMMARY OF THE INVENTION

A hand-held device is disclosed. The hand-held device includes a rotary wheel, a switch, a character region, and a controller. The rotary wheel has a plurality of positioning inputs. The character region comprises a plurality of icon areas corresponding to the positioning inputs, wherein each icon area comprises a plurality of characters. The controller selects characters of an icon area according to a positioning input the rotary wheel locates, and inputs a character of the characters according to a count the switch is operated.

Another kind of hand-held device with character input rotary wheel is disclosed. The hand-held device includes a rotary wheel, a switch, an encoder, a memory, and a controller. The rotary wheel has a plurality of positioning inputs. The encoder is responsive to operation on the rotary wheel and outputs positioning codes. The memory stores a plurality of characters corresponding to the positioning codes. The controller selects characters from the memory according to a positioning code the encoder outputs, and inputs a character of the characters according to a count the switch is operated.

Further features will be described or will become apparent in the course of the following detailed description when read in conjunction with the attached drawings, in which:

### BRIEF DESCRIPTION OF THE DRAWINGS

FIG. 1 is a schematic, front view of a hand-held device with a character input rotary wheel according to a preferred embodiment of the present invention; and

FIG. 2 is a schematic diagram of a hardware infrastructure of the hand-held device of FIG. 1.

### DETAILED DESCRIPTION OF THE INVENTION

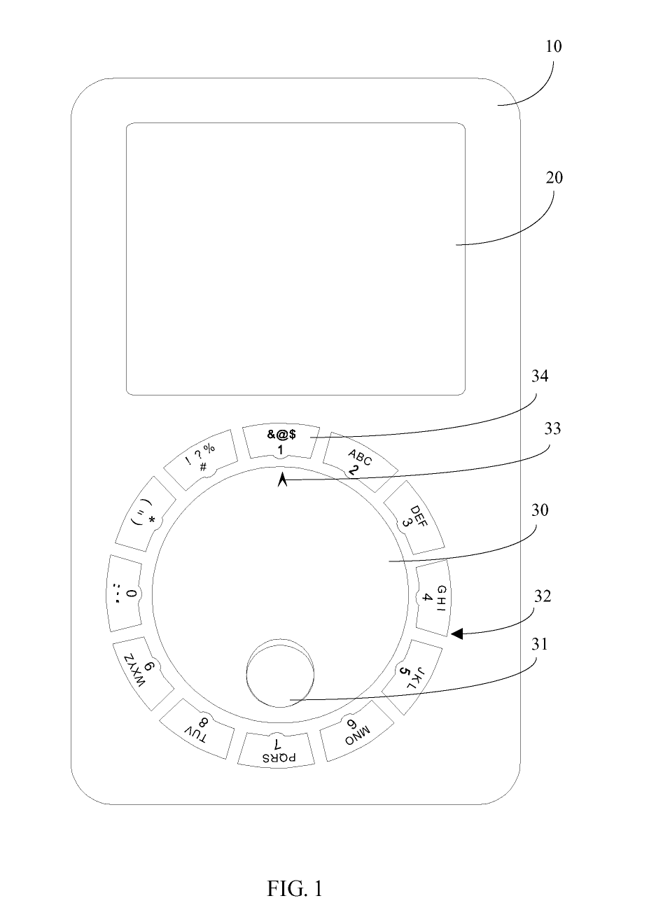

Referring to FIG. 1, a hand-held device is disclosed. The hand-held device 10 includes a display 20, a character region 32, and a rotary wheel 30. The rotary wheel 30 has twelve positioning inputs. The character region 32 has twelve icon areas 34 corresponding to the positioning inputs. The twelve icon areas 34 are arranged in a circle. Each icon area 33 may have one or more graphical labels. The one or more graphical labels can be any characters, for example, numbers, letters, symbols, or any combination of them. In this exemplary embodiment as shown in FIG. 1, the graphical labels of the icon area 33 are a combination of numbers, letters, and symbols. Furthermore, the graphical labels have a first character set and a second character set, each character set for depicting characters. For example, as displayed in FIG. 1, the first character set of the graphical labels provide multiple letters or symbols, and the second character set of the graphical labels provides a single number or symbol. Each icon area 33 can be in a from of a geometrical shape such as a square, a rectangle, a trapezium, a triangle, a circle, an ellipse, or any desired geometrical shape of a designer's choice. For example, in the embodiment as shown in FIG. 1, the icon areas 34 are trapeziums. Moreover, the icon areas 34 are the same, shape-wise or size-wise.

The hand-held device 1 further has an indicator 33. The indicator 33 is positioned on the rotary wheel 30 to indicate the positioning input of the rotary wheel 30; i.e., the rotary wheel 30 is turned (rotated), the indicator 33, thus, rotates within the rotary wheel 30, and the positioning input is determined where the indicator 33 aligns with one of the graphical label.

The hand-held device 1 further has a switch 31 for performing a select operation that selects through the one or more graphical symbols to be displayed. The switch 31 can be any appropriate input device. For example, in the embodiment as shown in FIG. 1, the switch 31 is a button. The switch 31 can be positioned at a center of the rotary wheel 30, off-centered of the rotary wheel 30 as shown in FIG. 1. The select operation on the switch 31 is described in detail below.

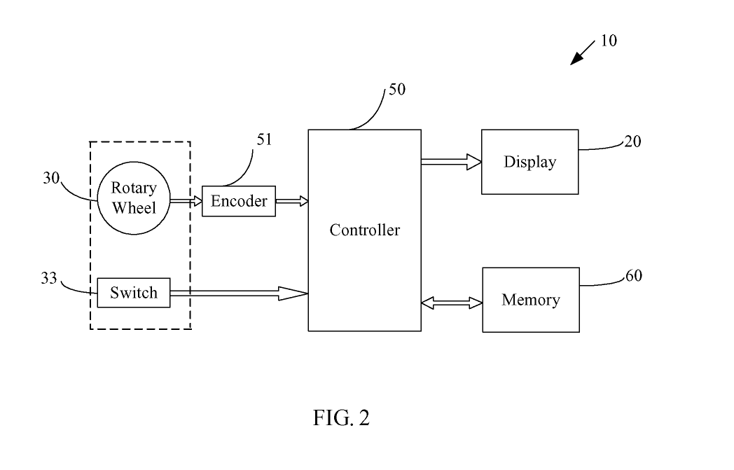

Referring to FIG. 2, a hardware infrastructure of the hand-held device 10 is disclosed. The hand-held device 10 further includes a controller 50, an encoder 51, and a memory 60. The controller 50 is electrically connected to the switch 31, the encoder 51, the display 20, and the memory 60. The encoder 51 is further connected to the rotary wheel 30 and generates a positioning code that corresponds to the positioning input of the rotary wheel 30. The memory 60 stores character codes of the icon areas 34 in the character region 32. In brief, the controller 50 reads the characters of the icon area 34 from the memory 60 according to the positioning code that the encoder 51 outputs. Furthermore, the controller 50 selects the character in response to the select operation of the switch 31.

For example, in response to the select operation of the switch 31, the controller 50 selects a first item (character) of the graphical labels, and sends the first item to the display 20. In response to two consecutive select operations within a predetermined time period (for example, 0.5 s), the controller 50 selects and sends a second item to the display 20. If characters belong to a same graphical label needs to be inputted one after another, the rotary wheel 30 needs to be operated again or wait for the predetermined time (for example, 0.5 s) to be passed before performing the select operation.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A hand-held device comprising:
a rotary wheel having a plurality of positioning inputs;
a switch;
a character region comprising a plurality of icon areas corresponding to the positioning inputs, wherein each icon area comprises a plurality of characters; and
a controller for selecting characters of an icon area according to a positioning input the rotary wheel locates, and inputting a character of the characters according to a count the switch is operated.

2. The hand-held device of claim 1, further comprising an indicator for indicating the positioning input of the rotary wheel.

3. The hand-held device of claim 2, wherein the indicator is placed on the rotary wheel.

4. The hand-held device of claim 1, wherein the switch is a button.

5. The hand-held device of claim 4, wherein the button is placed on the rotary wheel.

6. A hand-held device comprising:
a rotary wheel having a plurality of positioning inputs;
a switch;
an encoder responsive to operation on the rotary wheel and outputting positioning codes;
a memory storing a plurality of characters corresponding to the positioning codes; and
a controller for reading characters from the memory according to a positioning input the rotary wheel locates, and inputting a character of the characters according to a count the switch is operated.

7. The hand-held device of claim 6, further comprising a character region, the character region including a plurality of icon areas corresponding to the positioning inputs of the rotary wheel, each icon area including a plurality of characters.

8. The hand-held device of claim 6, further comprising an indicator for indicating the positioning input of the rotary wheel.

9. The hand-held device of claim 8, wherein the indicator is placed on the rotary wheel.

10. The hand-held device of claim 6, wherein the switch is a button.

11. The hand-held device of claim 10, wherein the button is placed on the rotary wheel.
